(19) United States
(12) Patent Application Publication
(10) Pub. No.: US 2007/0164618 A1
(43) Pub. Date: Jul. 19, 2007

(54) ROTARY ELECTRICAL MACHINE

(75) Inventors: Taihei Koyama, Tokyo (JP); Shinichi Noda, Kanagawa-ken (JP); Kenzo Tonoki, Tokyo (JP); Shigetomo Shiraishi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/615,164

(22) Filed: Dec. 22, 2006

(30) Foreign Application Priority Data
Dec. 27, 2005 (JP) 2005-375350

(51) Int. Cl. H02K 9/20; H02K 9/00

(52) U.S. Cl. 310/54; 310/64

(57) ABSTRACT

The main body of a rotary electrical machine is accommodated in a frame (1). A circulatory device (5) is provided that is rotated by a rotor (3) of said rotary electrical machine, in which there is accommodated cooling liquid (7) that cools at least the main body of the rotary electrical machine. The circulatory device (5) circulates said cooling liquid (7) to outside of the frame (1) by pump action. The cooling liquid (7) is accumulated by a reserve tank before being circulated within the frame (1). After the heated cooling liquid (7) is cooled in the reserve tank, this accumulated cooling liquid (7) is then caused to flow back into the frame (1) by the pressure difference.

### CROSS-REFERENCE TO RELATED APPLICATION

This application claims benefit of priority from Japanese Application No. JP 2005-375350 filed Dec. 27, 2005, the entire content of which is incorporated by reference herein.

### BACKGROUND OF THE INVENTION

1. Field of the Invention

The present invention relates to a rotary electrical machine of the liquid cooled totally enclosed type wherein cooling is performed by means of liquid.

2. Description of the Related Art

For example in the case of a railway vehicle such as an electric railcar (or an electric locomotive), a vehicle drive motor is mounted on a chassis arranged below the vehicle body, and the vehicle is driven by transmission of rotary force of the motor to the vehicle wheels through for example a gearbox.

With such a drive motor, the temperature of the various parts rises during running due to generation of heat from copper losses from the stator winding and rotor winding, iron losses from the stator, and, in addition, mechanical losses, with the risk of deterioration of insulation performance and decreased rotational efficiency.

A drive motor therefore requires a cooling action to lower the temperature of the heat generating parts, by provision of a cooling device.

As such motor cooling means, there was conventionally provided cooling means called an open self-ventilating cooling system wherein a cooling fan or blower is provided that is fixed to the rotor shaft within the motor and the interior of the motor is cooled by forcible introduction of a current of cold external air into the motor by rotation thereof.

However, with this open self-ventilating cooling system, there was concern that, since the interior and exterior of the motor were in communication, dust mixed with the introduced external air might penetrate into the motor, contaminating the interior of the motor.

In order to prevent this, a construction is adopted in which a ventilation filtration device is provided at the external air inlet port, so that dust can be captured by the filter in this ventilation filtration device.

However, it is difficult for the filter to capture all of the dust, so dust gradually penetrates into the motor and is deposited in its interior; this accumulation of dust lowers the insulation performance and cooling effect, giving rise to over-heating of the motor.

Maintenance such as cleaning of the interior of the motor and the filter at comparatively short intervals in order to prevent such lowering of insulation performance and cooling effect is therefore troublesome.

Furthermore, in the case of a motor with an open self-ventilating cooling system, considerable noise is inevitably produced by the resistance of the air and the rotation of the cooling fan or blower when external air is drawn in, due to the construction in which external air is drawn into the motor by rotation of a cooling fan or blower.

Accordingly, in recent years, instead of the open self-ventilating cooling system, a main motor of the totally enclosed external fan type, in which the main body of the main motor is hermetically sealed and cooling is performed by delivery of a current of air to the external peripheral surface of the main body, or a main motor of the totally enclosed internal fan type, utilizing circulation of an air current within the motor and the slipstream produced by a radiator has been adopted, such as for example Laid-open Japanese Patent Application H. 09-066829 (hereinbelow referred to as Patent Reference 1).

In general, regarding motors for vehicles, it is known that it is more efficient to mount a small number of main motors of high output in a single vehicle formation rather than mounting a large number of main motors of low output and the former i.e. to mount a small number of main motors of high output in a single vehicle formation is therefore demanded by the railway companies.

However, a main motor of the totally enclosed external fan type or a main motor of the totally enclosed internal fan type is of lower cooling efficiency than a motor of the open type, so, in order to obtain a motor of high output, the motor must be made of large size.

However, since a motor for vehicle drive is mounted in a restricted space below the chassis installed below the vehicle body, not only is it not possible to make this motor any larger but also in fact there is a demand to make the motor smaller and lighter than existing motors.

The present cooling system has reached its limit with regard to the reduction in size and weight that can be achieved with a motor of hermetically sealed construction and a novel cooling system is therefore necessary.

Various methods of cooling have previously been proposed, and, for railway use, water-cooled or liquid-cooled systems have attracted attention.

One means that may be adopted is liquid cooling means, in which an impeller is mounted at the end of the rotor shaft of the motor, and liquid coolant is circulated by pump action produced by rotation of the impeller produced by rotation of the rotor shaft during driving of the vehicle, the liquid coolant being thereby delivered into a liquid coolant flow path e.g. Laid-open Japanese Patent Application No. H. 10-285876 (hereinbelow referred to as Patent reference 2).

With such a construction, auxiliary equipment such as the pump or power source required in Patent Reference 1 become unnecessary, reducing the number of breakdowns of the cooling equipment and enabling the costs for equipment drive to be lowered.

However, in the cooling construction in a conventional vehicle drive motor as shown in Patent Reference 2 described above, the following problems require solution.

Specifically, since rotation of the impeller is effected by rotation of the rotor shaft connected therewith, when the vehicle is stationary as for example in a station, operation of the motor is normally stopped, so impeller rotation is also stopped, causing the action of circulating the cooling liquid to the coolant flow path by pump action produced by rotation of the impeller to be also stopped: the cooling action of the motor during this period is therefore stopped, causing the motor temperature to rise, with the risk of for example insulation breakdown or over-heating of the motor.

### SUMMARY OF THE INVENTION

Accordingly, in a rotary electrical machine using a pump utilizing rotation of a rotary shaft, such as for example of a vehicle drive motor, during driving of the vehicle, one object of the present invention is to provide a novel rotary electrical machine of the liquid cooled totally enclosed type wherein, even in a condition in which driving of the rotary electrical machine is stopped, the cooling function operates normally and damage or over-heating produced by generation of heat by the motor can be reliably prevented.

In order to achieve the above object, the present invention comprises the following construction. Specifically, the invention comprises:

a frame;

a rotary electrical machine main body accommodated in the frame;

cooling liquid accommodated in the frame and that cools at least the rotary electrical machine main body;

a circulation device rotated by a rotor of the rotary electrical machine and whereby cooling liquid is circulated to outside the frame by pump action; and

a reserve tank in which cooling liquid is accumulated and whereby after cooling the cooling liquid that was heated up by circulation of the cooling liquid within the frame the accumulated cooling liquid is returned into the frame by the pressure difference.

According to the present invention, in a rotary electrical machine employing a pump using rotation of a rotary shaft during operation of a vehicle such as for example a vehicle drive motor, even in a condition in which the operation of the rotary electrical machine is stopped, the cooling function operates normally and damage or over-heating produced by generation of heat by the rotary electrical machine can be reliably prevented.

### BRIEF DESCRIPTION OF THE DRAWINGS

A more complete appreciation of the present invention and many of the attendant advantages thereof will be ready obtained as the same becomes better understood by reference to the following detailed description when considered in connection with the accompanying drawings, wherein:

FIG. 1 is a perspective view showing a rotary electrical machine of the liquid cooled totally enclosed type according to a first embodiment of the present invention;

FIG. 2 is a detail axially sectioned front view (or a detail vertically-sectioned front view) with the right half sectioned along the line A-A of FIG. 1;

FIG. 3 is a perspective view showing a reserve tank of a rotary electrical machine according to a second embodiment of the present invention;

FIG. 4 is a perspective view showing a reserve tank of a rotary electrical machine according to a third embodiment of the present invention;

FIG. 5 is a perspective view showing a rotary electrical machine according to a fourth embodiment of the present invention;

FIG. 6 is a cross-sectional view showing a reserve tank of a rotary electrical machine according to a fifth embodiment of the present invention;

FIG. 7 is a cross-sectional view showing a reserve tank of a rotary electrical machine according to a sixth embodiment of the present invention;

FIG. 8 is a perspective view showing a rotary electrical machine according to a seventh embodiment of the present invention; and

FIG. 9 is a cross-sectional view showing a reserve tank of a rotary electrical machine according to an eighth embodiment of the present invention.

### DETAILED DESCRIPTION OF THE PREFERRED EMBODIMENTS

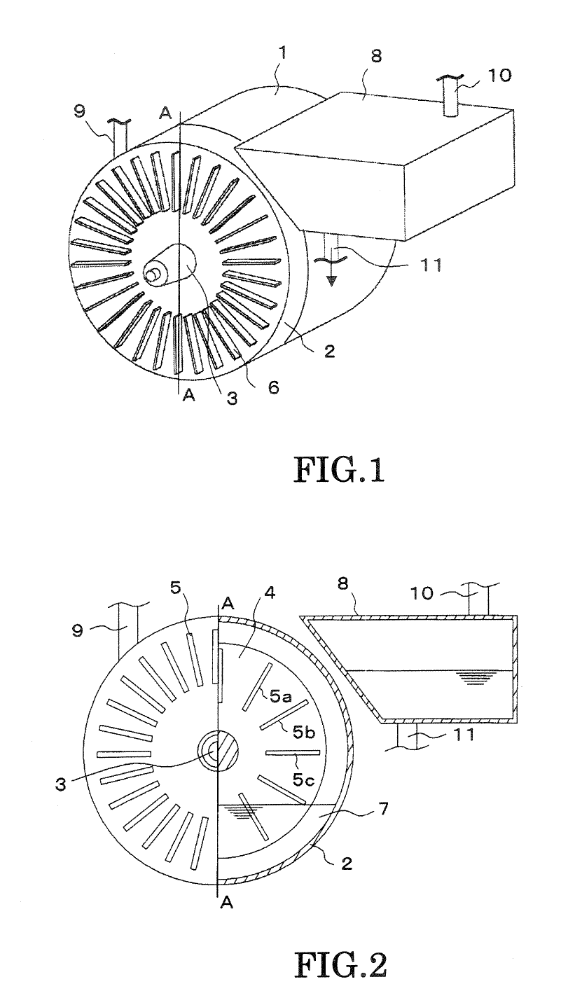

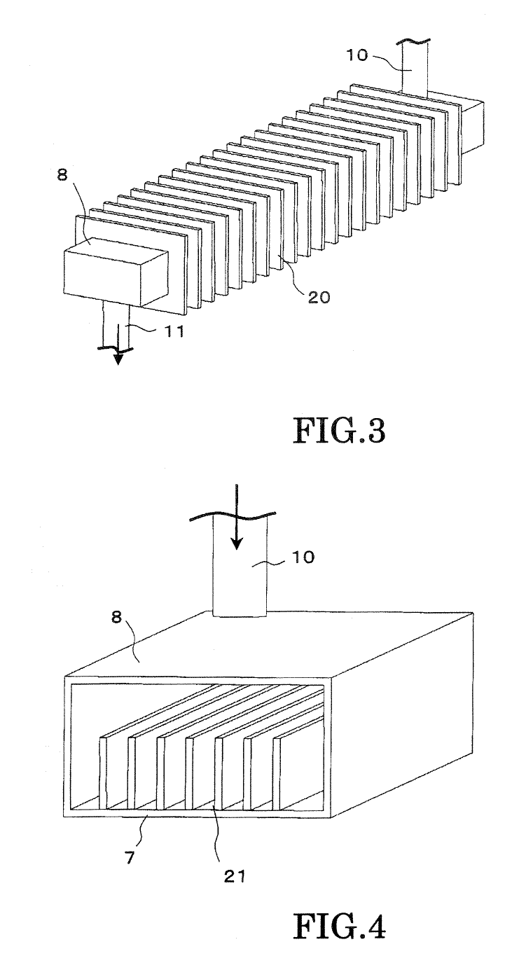

Referring now to the drawings, wherein like reference numerals designates identical or corresponding parts throughout the several views, and more particularly to FIG. 1 and FIG. 2 thereof, one embodiment of the present invention will be described.

FIG. 1 and FIG. 2 are views showing a rotary electrical machine according to a first embodiment of the present invention, FIG. 1 being a perspective view seen from the load side and FIG. 2 being a partial axially sectioned front view with the right half axially sectioned along the line A-A of FIG. 1.

In FIG. 1 and FIG. 2, 1 is the frame of a rotary electrical machine such as for example a motor for vehicle drive; the rotary electrical machine main body, comprising for example the rotor and stator of the rotary electrical machine, not shown, is accommodated in this frame 1.

2 is a pump box that is integrally formed at the end of the frame 1; a rotary shaft 3 of the motor projects to the outside through this pump box 2 from within the frame 1.

As can be seen in particular in FIG. 2, within the pump box 2, a rake disc 4 is fixed so as to be integrally rotated with the rotary shaft 3 of the motor.

5a, 5b, 5c . . . are a plurality of rake plates that are fixed to the plate surface of the rake disc 4 referred to above at substantially equal intervals in radial fashion about the rotary shaft 3 so as to project along the axial direction of the rotary shaft 3. This rake disc 4 and rake plates 5a, 5b, 5c . . . will be referred to together as a circulatory device.

6 are cooling fins that are formed projecting from the outside face of the pump box 2.

7 is cooling liquid consisting of a liquid such as for example water, that is introduced into the bottom of the pump box 2 such that part of the bottom of the rake disc 4 is immersed therein.

8 is a reserve tank that is fixed with a suitable separation at the side of frame 1, holding in its interior liquid 7 identical with the cooling liquid 7 held in the pump box 2.

9 is an introduction pipe that is mounted at the top of the frame 1 so as to communicate with the interior, and is connected with a liquid inlet pipe 10 that is formed in the upper face of the reserve tank 8.

11 is likewise a liquid outlet pipe that is mounted in the bottom face of the reserve tank 8 and is connected so as to supply the cooling liquid 7 in the reserve tank 8 into the pump box 2; this liquid outlet pipe is arranged tightly secured at a suitable position along its length to for example the interior of the main motor, its surface or the bearing surround.

In the above description, the liquid inlet pipe 10 was mounted on the upper face of the reserve tank 8, but it would also be possible to mount this on the side face of the reserve tank 8. Likewise also, the liquid outlet pipe 11 was mounted on the undersurface of the reserve tank 8, but could be mounted on the side face thereof.

However, a positional relationship must be adopted such that cooling liquid flowing in from the liquid inlet pipe 10 is discharged by gravity from the liquid outlet pipe 11.

Next, the operation of this embodiment will be described.

In FIG. 1 and FIG. 2, the rotary shaft 3 of the drive motor is rotated in a condition with for example the vehicle running; concurrently, the rake disc 4 and rake plates 5a, 5b, 5c . . . within the pump box 2 are also integrally rotated with the rotary shaft 3.

In this way, the cooling liquid 7 in the pump box 2 is thrown up by the rake plates 5a, 5b, 5c . . . , thereby introducing part of the cooling liquid in the pump box 2 into the inlet pipe 9, with the result that this cooling liquid subsequently flows into the reserve tank 8 from the inlet pipe 10 so that the action of the circulatory device 5 is performed.

In the course of this process, the frame 1 of the motor that is tightly secured to the liquid outlet pipe, and the control device etc, not shown, are cooled.

Some of the cooling liquid 7 that flows into the reserve tank 8 flows out from the liquid outlet pipe 11, but, if the rate of inflow is larger than the rate of outflow, some of this cooling liquid is retained in the reserve tank 8.

The cooling liquid 7 that is thus retained mixes with the cooling liquid already accumulated in the reserve tank 8 and is cooled.

When the vehicle that was being driven stops for example at a station, the rake disc 4 and rake plates 5a, 5b, 5c . . . are also stopped due to the stopping of the rotary shaft 3 of the motor, so the pump action of the rake plates 5a, 5b, 5c . . . ceases and no more cooling liquid flows into the reserve tank 8; however, an ample amount of cooling liquid is already accumulated in the reserve tank 8.

Consequently, even after stopping of driving of the vehicle at for example a station, cooling liquid 7 accumulated in the reserve tank 8 can continue to be fed back into the pump box 2 from the outlet pipe 11 for a time that is fully sufficient for cooling.

As described above, according to this embodiment, thanks to the outflow of cooling liquid from the liquid outlet pipe 11 for a time that is fully sufficient for cooling, even after the drive motor has stopped due to stoppage of the vehicle, the motor main body and control device can be cooled even while the vehicle is stationary, so damage due to generation of heat by the rotary electrical machine can be reliably prevented and overheating can be avoided.

Next, a second embodiment of the present invention is described with reference to FIG. 3. In the description of the following embodiments, parts that are the same as in the case of the first embodiment of the present invention shown in FIG. 1 and FIG. 2 described above are given the same reference symbols and further detailed description thereof is dispensed with.

In this embodiment, a large number of comb tooth shaped heat radiating fins 20 are formed on the outer surface of the reserve tank 8, that is formed in the shape of a rectangular prism, but other details are the same as in the case of the first embodiment described above.

While heat radiating fins 20 may be formed over the entire outer surface of the reserve tank 8, some of these may be absent in view of dimensional considerations. The direction of arrangement of the heat radiating fins 20 may be perpendicular to the axial direction of the rotary shaft 3 of the motor.

Also, regarding the length of the fins 20, the fins should be as long and thin as possible, although restrictions are imposed by strength and dimensions.

Also, while the separation of the fins should be as small as possible, since they are exposed to the outside, dust may be deposited on them by the slipstream, and the separation is therefore preferably determined taking into consideration the relationship with running speed.

Regarding the mounting of the liquid inlet pipe 10 and liquid outlet pipe 11, the same positional relationships may be adopted as in the case of the first embodiment described above.

With the present embodiment as described above, thanks to the formation of heat radiating fins 20 on the outer surface of the reserve tank 8, heat from the cooling liquid 7 that has flowed into the reserve tank 8 is transmitted to the heat radiating fins 20 through the reserve tank 8 and dispersed from the heat radiating fins 20.

Also, thanks to the formation of the heat radiating fins 20 in the direction perpendicular to the axial direction of the rotary shaft of the main motor, the slipstream can flow between the fins.

With the embodiment described above, the heat radiating area of the reserve tank 8 is increased, making it possible to increase the cooling effect.

Also, the slipstream can be entrained between the heat radiating fins 20 during running of the vehicle, so the heat transfer factor of the heat radiating fins is increased, thereby making it possible to increase the cooling efficiency.

Next, a third embodiment of the present invention is described with reference to FIG. 4.

In this embodiment, a plurality of heat absorbing fins 21 are erected from the bottom in the reserve tank 8.

Although in this case the heat absorbing fins 21 are formed from the bottom face of the reserve tank 8, they could be arranged on the top face or side face, or a combination of these arrangements could be employed.

There are no particular restrictions regarding the number or dimensions of the heat absorbing fins 21 and these may be a determined taking into consideration flow of cooling liquid or strength.

Although in FIG. 4 nothing is mounted on the outer peripheral surface of the reserve tank 8, heat radiating fins 20 could be mounted thereon as in the case of the second embodiment.

Also, regarding the positions of the liquid inlet pipe 10 and liquid outlet pipe 11, the same positional relationships may be adopted as in the case of the first embodiment described above.

Thanks to the formation of the heat absorbing fins 21 in the reserve tank 8 in accordance with this embodiment constructed as above, heat from the cooling liquid 7 retained in the reserve tank 8 is transmitted to the heat absorbing fins 21 and is thence radiated to the external atmosphere by transmission through the frame of the reserve tank 8.

With this embodiment as described above, the heat of the cooling liquid 7 can easily be transmitted to the frame of the reserve tank 8 by the heat absorbing fins 21, so the cooling efficiency can be increased.

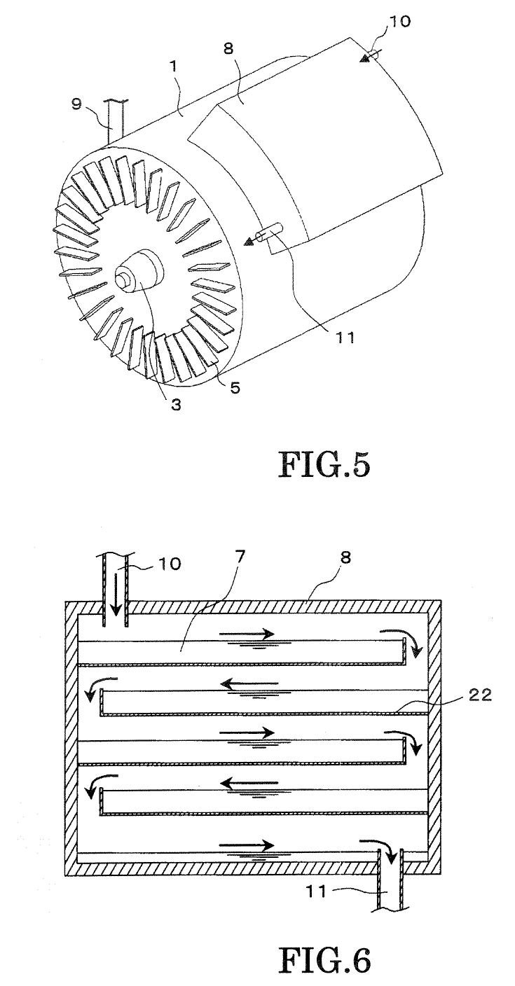

Next, a fourth embodiment of the present invention is described with reference to FIG. 5. In this embodiment, the reserve tank 8 is formed tightly secured to or of integral construction with the external peripheral face of the frame 1 of the main body of the motor.

Since the reserve tank 8 is arranged along the outer peripheral surface of the frame 1 of the main body of the motor, preferably at least the face contacting the external peripheral surface of the frame 1 is formed of an arcuate surface shape conforming thereto, but it would also be possible to adopt a shape of a linear construction, as shown in the embodiment described above.

However, one face of the reserve tank 8 must be tightly secured to the external peripheral surface of the frame 1 of the main body of the motor.

Although nothing is arranged on the outer peripheral surface of the reserve tank 8, as in the case of the second embodiment described above, heat radiating fins 20 could be mounted thereon, or heat absorbing fins 21 could be provided within the reserve tank 8 as in the case of the third embodiment described above.

With this embodiment constructed as described above, thanks to the tight securing of the reserve tank 8 to the external peripheral surface of the frame 1 of the main body of the motor, heat generated from the main body of the motor is transmitted to the frame of the reserve tank 8 and is thence dispersed. In addition, the heat that is dispersed by the frame is thermally transmitted to the cooling liquid 7 within the reserve tank 8, which is at a lower temperature.

With this embodiment as described above, the heat of the main body of the motor is efficiently transmitted to the reserve tank 8, so the cooling efficiency can be raised.

Also, when the outer peripheral surface of the main body of the motor is cooled, not only does the temperature in the vicinity thereof drop but also the temperature within the motor drops, so there is a fall not only in the temperature at the stator side but also in the temperature at the rotor side, thereby increasing the efficiency of cooling.

Next, a fifth embodiment of the present invention will be described with reference to FIG. 6.

In this embodiment, partition plates 22 that partition the space within the reserve tank 8 into a plurality of layers are alternately formed on the inside faces of the reserve tank 8 from both side faces thereof.

Each of the partition plates 22 is bent at its tip in the perpendicular direction, forming an L shape in cross-section. This therefore induces cooling liquid 7 flowing into the reserve tank 8 from the liquid inlet pipe 10 at the upper side of the partition plates 22 to be retained therein.

Four partition plates 22 are shown in FIG. 6, but the extent to which the cooling liquid 7 is retained increases as the number of plates is increased.

Also, although nothing is formed on the outer peripheral surface of the reserve tank 8 in FIG. 6, it would be possible to mount heat radiating fins thereon, as in the case of the second embodiment described above.

With this embodiment constructed as described above, the cooling liquid 7 that has flowed in from the liquid inlet pipe 10 is mixed with cooling liquid 7 that was retained beforehand by accumulation of cooling liquid 7 utilizing the partition plates 22, and cooling liquid 7 overflowing from the partition plates 22 drops down under its own weight to the lower partition plates 22, where it is accumulated. By successively repeating this process, the cooling liquid that has flowed into the reserve tank 8 is cooled while being progressively mixed with retained cooling liquid 7, before finally flowing out from the liquid outlet pipe 11.

Thus, as described above, with this embodiment, cooling liquid 7 that has flowed in from the liquid inlet pipe 10 is cooled by passing the partition plates 22 within the reserve tank 8 before flowing out from the liquid outlet pipe 11. In this way, the cooling efficiency of the circulating cooling liquid can be further increased.

Also, by retaining the cooling liquid 7 within the reserve tank 8 after stopping of the vehicle, the temperature of the cooling liquid 7 can be lowered.

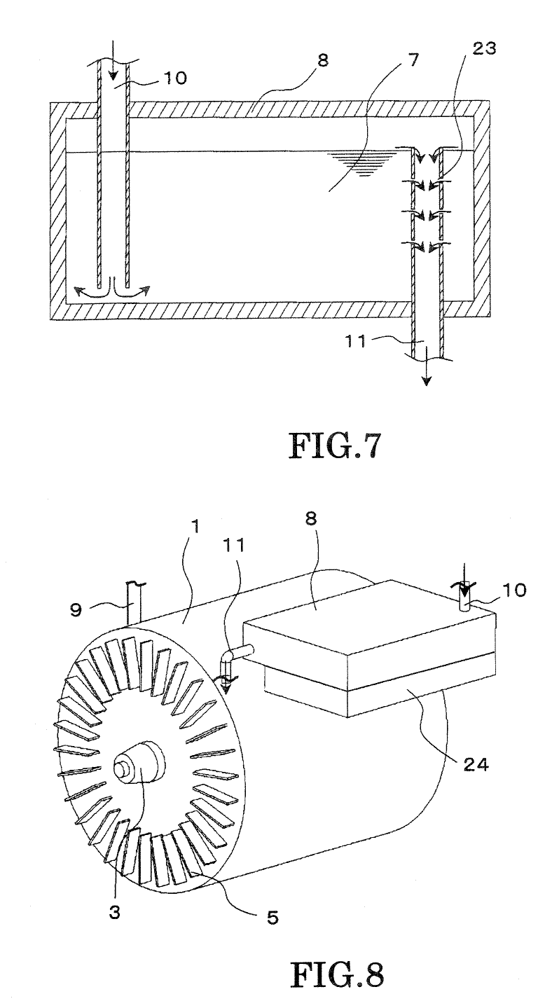

Next, a sixth embodiment of the present invention will be described with reference to FIG. 7.

In this embodiment, the end of the liquid inlet pipe 10 is provided submerged to such an extent that it reaches the vicinity of the bottom face of the reserve tank 8.

Also, the end of the liquid outlet pipe 11 is provided raised to such extent as to reach the vicinity of the upper face of the reserve tank 8.

The liquid inlet pipe 10 has a construction inserted from the upper face of the reserve tank 8, but it would also be possible to adopt a positional relationship in which this liquid inlet pipe 10 is inserted from the side face and bent in the perpendicular direction within the reserve tank, so that its end is provided in the vicinity of the bottom face, so that backflow of the cooling liquid cannot occur.

Furthermore, regarding the liquid outlet pipe 11, instead of a construction in which this liquid outlet pipe 11 is inserted from the bottom face of the reserve tank 8, a construction could be adopted in which it is inserted from a side face thereof.

Also, a plurality of outlet holes 23 could be provided in the liquid outlet pipe 11, so that cooling liquid 7 is discharged from the outlet holes 23 formed in corresponding positions by the water pressure, in accordance with the water level of the cooling liquid 7.

With this embodiment constructed described above, thanks to the arrangement of the liquid inlet pipe 10 and liquid outlet pipe 11 in a positional relationship as in FIG. 7, the cooling liquid 7 is mixed with the cooling liquid 7 within the reserve tank 8.

When the internal water level rises, the height of the end of the liquid outlet pipe 11 is exceeded, with the result that outflow of the liquid takes place to the outside through the liquid outlet pipe 11 due to gravity. Also, the liquid is expelled from the outlet holes 23 by water pressure, depending on the water level of the cooling liquid 7.

With this embodiment, as described above, cooling liquid 7 that flows in from the liquid inlet pipe 10 in a heated condition mixes with the cooling liquid 7 retained in the reserve tank 8 at a lower temperature than this, and its temperature is therefore lowered.

Also, the end of the liquid inlet pipe 10 and the end of the liquid outlet pipe 11 are widely separated from each other, so thorough mixing occurs with the cooling liquid 7 in the reserve tank 8, resulting in a fully sufficient drop in temperature before the liquid is allowed to flow out from the liquid outlet pipe 11.

The temperature of the cooling liquid can therefore be sufficiently lowered before it is discharged to outside the reserve tank 8.

Also, due to the provision of outlet holes 23, even after inflow from the liquid inlet pipe 10 has ceased after stoppage of the vehicle, cooling liquid can still be delivered to the motor and control device for a fully sufficient period for achieving cooling by the cooling liquid 7 retained in the reserve tank flowing out from the outlet holes 23 depending on the water level thereof, so rise in temperature of the various units can be suppressed.

Next, a seventh embodiment of the present invention will be described with reference to FIG. 8. In this embodiment, the control device 24 is arranged tightly secured to or in an integral construction therewith at the underside of the reserve tank 8.

Although in FIG. 8 the control device 24 was smaller than the reserve tank 8, there is no particular restriction regarding the size relationship thereof, so long as the construction is such that the reserve tank 8 and the control device 24 are tightly secured at one face. However, the control device 24 must be in a positional relationship on the underside of the reserve tank 8. The reserve tank 8 and the control device 24 are both constructed as rectangular prisms and may be of a shape as described in the first embodiment.

With this embodiment constructed as described above, the flow of cooling liquid 7 is basically the same as in the case of the first embodiment described above. The flow shown in the respective embodiments is produced when the construction within the reserve tank 8 is as in the third, fifth and sixth embodiments.

With this embodiment as described above, the heat generated in the control device 24 can be directly transmitted to the reserve tank 8.

Since the cooling liquid 7 is retained at the bottom face side in the reserve tank 8, the heat generated by the control device 24 can be removed and cooling thereby effected.

In the conventional construction (not shown), the cooling equipment 24 was arranged in a location separated from the main body of the motor, and cooling was effected by separately mounting a blower or a heat radiating fan of large weight and volume. By installing this control device immediately adjacent to the motor, so that this control equipment is cooled together with the cooling of the motor, the equipment or constructions that were previously necessary for cooling the control device 24 are made unnecessary, making it possible to reduce the overall size and weight.

Also, by arranging the control device close to the main body of the motor, the wiring from the control device 24 to the main body of the motor can be shortened to the necessary minimum, making it possible to improve ease of maintenance and reliability.

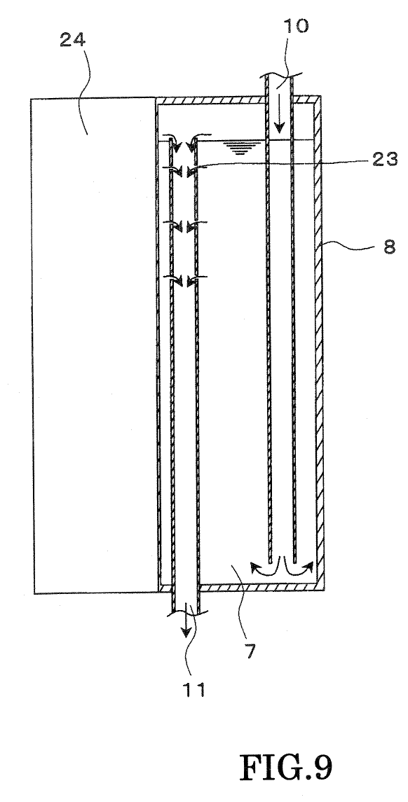

Next, an eighth embodiment of the present invention is described with reference to FIG. 9.

In this embodiment, the control device 24 and the reserve tank 8 are arranged next to each other vertically, so that these two are tightly secured together.

Within the reserve tank 8, just as in the case of the sixth embodiment described above, the end of the liquid inlet pipe 10 is arranged in the vicinity of the bottom face within the reserve tank 8. Also, the end of the liquid outlet pipe 11 is arranged in the vicinity of the top face within the reserve tank 8.

As shown in the Figure, the frame of the reserve tank 8 on the side where the reserve tank 8 and the control device 24 are tightly secured together is of small thickness. Although in the Figure the control device 24 is arranged on the left side of the reserve tank 8, it could be arranged on the right side thereof.

With this embodiment constructed as described above, just as in the case of the seventh embodiment described above, the heat generated by the control device 24 can be transmitted to the reserve tank 8.

Since the cooling liquid 7 is retained at the bottom face side of the reserve tank 8, the heat generated by the cooling device 24 can be removed and cooling thereby effected.

It should be noted that, although, in the description of the embodiments given above, the present invention was applied to a vehicle drive motor as an example, the present invention is not restricted to this and could also be embodied as another type of rotary electrical machine.

What is claimed is:

1. A rotary electrical machine comprising:
a frame;
a main body of said rotary electrical machine accommodated in said frame;
cooling liquid to cool at least said main body of said rotary electrical machine, accommodated in said frame;
a circulatory device rotated by a rotor of said rotary electrical machine, whereby said cooling liquid is circulated to an outside of said frame by pump action; and
a reserve tank whereby said cooling liquid is caused to flow back into said frame after being accumulated.

2. The rotary electrical machine according to claim 1,
further comprising a plurality of heat radiating fins arranged at an outer surface of said reserve tank.

3. The rotary electrical machine according to claim 2, wherein said heat radiating fins are long and thin.

4. The rotary electrical machine according to claim 1,
wherein heat absorbing fins are provided in an interior of said reserve tank.

5. The rotary electrical machine according to claim 1,
wherein said interior of said reserve tank comprises said reserve tank interior and bottom face side.

6. The rotary electrical machine according to claim 1,
wherein said interior of said reserve tank comprises said reserve tank interior and side face side.

7. The rotary electrical machine according to claim 1,
wherein said interior of said reserve tank comprises said reserve tank interior and top face side.

8. The rotary electrical machine according to any of claims 1 to 3,
wherein said reserve tank is provided tightly secured to said frame of said rotary electrical machine.

9. The rotary electrical machine according to any of claims 1 to 3,
wherein partition plates whereby cooling liquid is retained are alternately provided in a horizontal direction, from two side faces within said reserve tank.

10. The rotary electrical machine according to any of claims 1 to 3,
further comprising a liquid inlet pipe whereby cooling liquid flows into said reserve tank; and
a liquid outlet pipe whereby cooling liquid flows out, wherein an end of said liquid inlet pipe is in a vicinity of a bottom face within said reserve tank and an end of said liquid outlet pipe is arranged in a vicinity of a top face within said reserve tank, a plurality of outlet holes being provided in said liquid outlet pipe.

11. The rotary electrical machine according to any of claims 1 to 3,
wherein an end of said liquid inlet pipe is provided submerged to an extent so as to reach a vicinity of a bottom face within said reserve tank.

12. The rotary electrical machine according to any of claims 1 to 3,
wherein an end of said liquid outlet pipe is provided submerged to an extent so as to reach a vicinity of a top face within said reserve tank.

13. The rotary electrical machine according to any of claims 1 to 3,
wherein said liquid outlet pipe comprises a plurality of outlet holes.

14. The rotary electrical machine according to any of claims 1 to 3,
wherein a control device is installed tightly secured to said reserve tank.

15. The rotary electrical machine according to any of claims 1 to 3,
wherein a control device is installed tightly secured to a side face of said reserve tank.
